(19) United States
(12) Patent Application Publication
(10) Pub. No.: US 2021/0180918 A1
(43) Pub. Date: Jun. 17, 2021

(54) CAMOUFLAGE PATTERN AND METHOD OF MAKING SAME

(71) Applicant: Tyler Appling, St. Louis, MO (US)

(72) Inventor: Tyler Appling, St. Louis, MO (US)

(21) Appl. No.: 17/185,888

(22) Filed: Feb. 25, 2021

(51) Int. Cl. F41H 3/02; A41D 31/04

(52) U.S. Cl. CPC F41H 3/02; A41D 2600/108; A41D 31/04

(57) ABSTRACT

A camouflage pattern that integrates animals and animalistic features (antlers, feathers, fur) are strategically embodied within each layer of the digital camouflage patterns to create a unique form of camouflage. Also, disclosed is a method of encoding the camouflage pattern on a substrate.

### FIELD OF INVENTION

The present invention relates to a camouflage pattern, and more particularly the present invention relates to a camouflage pattern and a method of encoding the camouflage pattern on a substrate.

### BACKGROUND

Camouflage patterns using digital patterns or vegetation such as tree bark, grass blades, etc., are known in the art. Camouflage patterns have been known for use in several articles and applications. The primary use of camouflage pattern is in the clothing articles, wherein the camouflage patterns are used such that the wearer of the clothing article remains hard to detect visually in a particular environment. Hunters, outdoorsmen, and the military generally uses the camouflaged clothing articles to blend themselves in the immediate environment.

However, the traditional camouflage patterns are limited to few designs that include trees and grasses. Such known camouflage patterns have become common and provide limited disguise. Due to the use of the same elements in the camouflage pattern, the known camouflage can be recognized easily resulting in a limited disguise.

Thus, a need is appreciated for the camouflage patterns having a unique set of elements that provide a unique form of camouflage.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a camouflage pattern having a unique set of elements.

It is another object of the present invention that the disclosed camouflage pattern provides enhanced disguise.

It is still another object of the present invention that the camouflage pattern is unique.

It is yet another object of the present invention that the camouflage pattern is having an aesthetic appearance.

It is a further object of the present invention that the camouflage pattern provides an optimum level of protection for the hunters and outdoorsmen.

In one aspect, disclosed is a camouflage pattern that integrates animals and animalistic features (antlers, feathers, fur) strategically embodied within each layer of the digital camouflage patterns to create a unique form of camouflage. Also, disclosed is a method of encoding the camouflage pattern on a substrate.

These and other objects and advantages of the embodiments herein and the summary will become readily apparent from the following detailed description taken in conjunction with the accompanying drawings.

### BRIEF DESCRIPTION OF DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a front view of a camouflage pattern, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

Disclosed is a novel camouflage pattern and method of encoding the camouflage pattern on a substrate. The substrate can be any utility articles, such as clothing. The clothing can include shirts, jackets, coats, uniforms, rain gear, footwear, headgear, vests, outerwear, tank tops, robes, undergarments, neckties, suspenders, socks, shoes, boots, slippers, sandals, scarves, jerseys, and athletic uniforms, gloves, mittens, stockings, pajamas, nightshirts, skirts, belts, caps, hats, baseball caps, visors, headbands and sweatbands, earmuffs, bandanas, bibs, and any other covering designed to be worn on a person's body. The camouflage pattern can be repeated throughout at least a portion of the surface of the utility article.

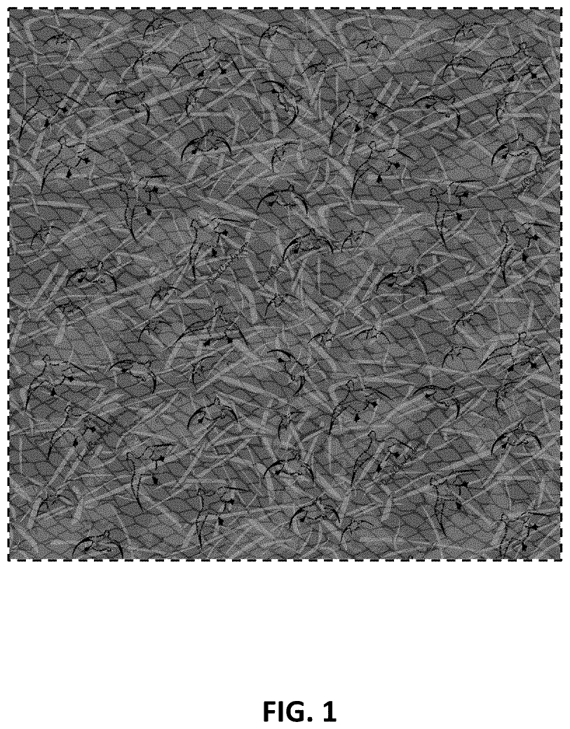

The camouflage pattern includes integrated animals and animalistic features (antlers, feathers, fur) strategically embodied within each layer of the digital camouflage. Referring to FIG. 1, which shows an exemplary embodiment of the camouflage pattern which is a multilayer digital print having at least one layer of animals and animalistic features.

Firstly, indicia of the animals and animalistic features can be processed to contain only the outlines and silhouettes. These modified indicia can then be further processed to be strategically sized and positioned within a layer of digital patterns. Preferably, the outlines and silhouettes can be interweaved between layers of digital patterns, wherein the combination accentuates the overall effectiveness of the pattern to break up the visual ability to fixate on the object it is applied to.

FIG. 1 shows ducks as the animal figure for the duck hunters. The outlines of animal and animalistic features in FIG. 1 include the cupped wings of the duck with the feet down in the landing position. The disclosed invention utilizes digitally modified versions of antlers with compatible digital patterns and when combined, are visually appealing and extremely marketable.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A method of encoding a camouflage pattern on a substrate, the method comprising the steps of:
providing one or more digital indicia of animals and animalistic features;
processing the one or more indicia to obtain outlines and silhouettes layer; and
interweaving the outlines and silhouettes layer within layers of digital patterns to form a composite repeatable pattern.

2. The method according to claim 1, wherein the animals and animalistic features include ducks.

3. The method according to claim 1, wherein the substrate is a clothing article, and the camouflage pattern is repeated throughout at least a portion of the surface of the clothing article.

4. A clothing article having a camouflage pattern repeated throughout at least a portion of the surface of the clothing article, the camouflage pattern encoded using the steps of:
providing one or more digital indicia of animals and animalistic features;
processing the one or more indicia to obtain outlines and silhouettes layer; and
interweaving the outlines and silhouettes layer within layers of digital patterns to form a composite repeatable pattern.

5. A camouflage pattern comprising:
at least one layer of outlines and silhouettes of animal and animalistic features, wherein the at least one layer of outlines and silhouettes is interweaved between layers of digital patterns.
